(19) United States
(12) Patent Application Publication
(10) Pub. No.: US 2005/0176507 A1
(43) Pub. Date: Aug. 11, 2005

(54) Method of enabling a wireless information device to access betting related services

(76) Inventors: Eithan Ephrati, London (GB); Amir Langer, London (GB)

Correspondence Address: Richard C Woodbridge;Synnestvedt Lechner & Woodbridge, P O Box 592, Princeton, NJ, 08542-0592, US

(21) Appl. No.: 10/509,646

(22) PCT Filed: Apr. 17, 2003
(86) PCT No.: PCT/GB03/01663

(30) Foreign Application Priority Data
Apr. 17, 2002 (GB) 02087823

(51) Int. Cl. A63F 13/00; H04M 3/42

(52) U.S. Cl. 463/39; 455/414.1

(57) ABSTRACT

A wireless information devices can access betting related services by: (a) receiving and displaying the best odds on an event as automatically selected from odds offered by two or more bookmakers; (b) displaying an option to initiate placing a bet at the best odds; and (c) sending instructions to place the bet. This approach integrates an automated search function, that can identify the best available odds, with a mechanism to actually place a bet at the best odds. The automated search function avoids the need to display a long list of bookmakers names and related odds. This is the first step in simplifying the user interaction needed to place a bet. The second step is to integrate the display of the best odds with an option to initiate placing a bet. The option, if selected, sends instructions to place the bet. This form of integration avoids the need to navigate from an odds checking site to a bookmakers site, finding the relevant event on the bookmakers site and then placing a bet, which can be slow and awkward on a wireless information device.

### BACKGROUND OF THE INVENTION

1. Field of the Invention

This invention relates to a method of enabling a wireless information device to access betting related services, particularly betting related services (namely finding odds and allowing a bet to be placed) that are offered by several different entities. The term ‘wireless information device’ used in this patent specification should be expansively construed to cover any kind of end-user device with two way wireless information capabilities and includes without limitation radio telephones, smart phones, communicators, personal computers, computers and application specific devices. It includes devices able to communicate in any manner over any kind of network, such as GSM or UMTS, CDMA and WCDMA mobile radio, Bluetooth, IrDA etc.

2. Description of the Prior Art

Betting on a mobile telephone currently requires an end-user to first locate a WAP betting site that allows the end-user to specify a sporting event for which odds are required and to place a bet on that site. These sites are tied to a single bookmaker (see for example the Ericsson Mobile Interbet offering). The disadvantage to the end-user is that he may need to visit several different sites to get the most favourable odds; on a wireless information device with a small screen, such as a mobile telephone, navigating to different sites can be awkward and also time consuming; as a consequence, the user may just stick with one site. But that in itself acts as disincentive for end-users to place bets since they may feel uncomfortable being locked into just one bookmaker. Further, WAP sites generally attempt to mimic the user experience of using a web site: this is too cumbersome for a Wireless information device however.

An alternative is for the end-user to go to a WAP site which can deploy a search agent to automatically search different bookmakers' WAP sites and list all of those odds, or even automatically locate the most favourable odds (see www.oddschecker.com). The disadvantage with this approach is that deploying the search agent may be slow and awkward. Further, once the most favourable odds have been located, the end-user then has to navigate to the relevant WAP bookmaker's site and then repeat the process of identifying the event to bet on. The entire process is again slow and awkward and unsuited to the need for betting applications on wireless information devices to be fast and simple to use.

### SUMMARY OF THE INVENTION

The present invention envisages, in a first aspect, a method of enabling a wireless information device to access betting related services, comprising the steps of:
(a) receiving and displaying on the device the best odds on an event as automatically selected from odds offered by two or more bookmakers;
(b) displaying on the device an option to initiate placing a bet at the best odds; and
(c) sending from the device instructions to place the bet.
   Hence, the prior art deficiencies are overcome by integrating an automated search function that can identify the best available odds, with a mechanism to actually place a bet at the best odds. ‘Odds’ includes any ratio or formula that relates a bet to potential winnings and hence also includes spread betting odds; ‘event’ covers any kind of event on which odds are available, whether related to sporting, political, entertainment, finance, exchange rates, financial indices, commodity prices etc or otherwise. The automated search function avoids the need to display a long list of bookmakers names and related odds. This is the first step in simplifying the user interaction needed to place a bet. The second step is to integrate the display of the best odds with an option to initiate placing a bet. The option, if selected, sends instructions to place the bet.

This form of integration is especially valuable for a wireless information device, such as a mobile telephone, since these devices usually have small screens sizes and small keyboards, making complex user interaction (such as scrolling long lists of odds, navigating from an odds checking site to a bookmakers site, finding the relevant event on the bookmakers site and then placing a bet) slow and awkward. This approach can also minimise the number of interactions needed between the device and a remote server; since each interaction can take some seconds due to the inherent latency of wireless networks, reducing the number of separate interactions can considerably speed up the entire process.

Specific implementation details are that: the best odds and the option to initiate placing a bet at the best odds are displayed together on the same screen so that the user does not have to navigate to a different screen in order to initiate placing the bet. Alternatively, each can be displayed on hyper-linked screens so that the end-user does not have to manually navigate to and open a different remote site to move from one to the other.

The option to initiate placing a bet may be one or more of:
(a) highlighting or underlining the name of the event, team or player for which the best odds have been located.
(b) a dedicated button or icon;
(c) a statement defining the format of a message reply that would need to be sent from the device in order for a bet to be placed.

The device may initiate betting by sending a single instruction to find the best odds on a sporting event. This single instruction can be processed by a web agent that automatically searches one or more of the following, defining available odds:
(a) web or WAP sites from two or more bookmakers;
(b) databases controlled by two or more bookmakers;
(c) back-end processing systems of two or more bookmakers;
(d) a data stream received from any of the above.

Instead of an instruction from the device to locate the best odds, it is also possible to send and display on the device a tip relating to an event, the tip giving the name of the event and the applicable odds, which are the best available odds offered by two or more bookmakers. To place a bet, the user can just reply with the requested amount. This tip can be automatically generated using the above web agent running a server remote from the device; it therefore involves a server initiated user session. The tip may be sent only in respect of pre-defined categories of bets (e.g. tips relating to the end-user's favourite team or player). The device is therefore able to display an option to select a favourite team or sportsperson and send instructions to select a specific favourite team or sportsperson. The device can then receive and display the best odds on a sporting event relating to the selected team or sportsperson, display an option to initiate placing a bet at the best odds and send instructions to place the bet.

Other implementation details are that the device can display a series of menu options which, when selected, enable an end-user to open an account with a bookmaker and credit that account with money. Hence, sending from the device instructions to place the bet causes the account to be debited and winning a bet causes the account to be credited.

In a second aspect, there is a wireless information device programmed to access betting related services, in which the device is operable to:
(a) receive and display the best odds on a sporting event, as automatically selected from odds offered by two or more bookmakers;
(b) display an option to initiate placing a bet at the best odds;
(c) send instructions to place the bet.

In a third aspect, there is a wireless network operator that controls a wireless network, in which the network carries data traffic to a wireless information device to enable the device to receive and display the best odds on a sporting event as automatically selected from odds offered by two or more bookmakers; and carries data traffic from the device to enable the device to place a bet in response to an end-user selecting an option displayed on the device to initiate placing a bet at the best odds.

### BRIEF DESCRIPTION OF THE DRAWINGS

The present invention will be drafted with reference to the accompanying Figures, in which:

FIG. 1 is a main betting menu displayed on a wireless information device;

FIG. 2 shows the different screens displayed on the device for a WAP based implementation showing account related information;

FIG. 3 is the main soccer betting menu for the WAP based implementation;

FIG. 4 shows the different screens displayed on the device for the WAP based soccer implementation showing how the best odds are displayed and how a bet can be initiated;

FIGS. 5 and 6 shows the different screens illustrating how the ‘favourite team’ function works in the WAP based soccer implementation;

FIG. 7 shows the main golf betting menu for the WAP based implementation;

FIG. 8 shows how different golf tournaments can be selected and the best odds displayed;

FIG. 9 shows the different screens illustrating how the ‘favourite team’ function works in the WAP based golf implementation;

FIG. 10 shows the different screens illustrating how the ‘favourite team’ function works in the WAP based golf implementation;

FIGS. 11 and 12 shows how bets are initiated and confirmed in the WAP based soccer implementation;

FIGS. 13 and 14 shows the overall process flow for a SMS based soccer implementation;

FIG. 15 shows the overall process flow for a SMS based golf implementation;

FIG. 16 shows the process flow for withdrawing money in a SMS based implementation.

### DETAILED DESCRIPTION

The present invention will be described with reference from an implementation from Cellectivity Limited of London, United Kingdom called Bet Cellect™.

Bet Cellect solution is based on an application server, which interacts with, and integrates three components that constitute a complete m-Commerce circle.

First, the Bet Cellect betting application running on the application server can access, interact with and act upon any web based service or content selected by an end-user. Second, it communicates with the end-user in an effective, straightforward and minimal way, even when dealing with complex and sophisticated tasks. And finally, it integrates with the wireless network operator's business logic, billing and profiling systems, to enable real control and ownership of the activity by the carrier.

The Bet Cellect application server utilise a technology called Web Agents to achieve the above. Web Agents is described in detail in PCT/GB2002/003702, to which reference should be made and the disclosure of which is therefore incorporated by reference. Web Agents will be briefly described below.

Web Agents

Web agents is a web interaction system which enables a mobile telephone to interact with web resources. The web interaction system extracts information from web sites and performs queries on that information to (for example) locate the best available odds on an event from several bookmakers and place bets at the best odds, open accounts with bookmakers and debit/credit those accounts with bets/winnings. The web interaction system is located in a server remote from the mobile telephone and communicates with it over a wireless WAN, e.g. a GSM network.

The web interaction system comprises a query engine which operates on XML format data obtained from content data extracted from a web site, the query engine parsing the XML format data into SAX events which are then queried by the query engine.

Conventional query engines parse XML into a data object model (DOM) tree and not SAX events; DOM trees have certain advantages over SAX events in that, once constructed, it enables complex query processing by navigating through the DOM tree. DOM trees can however occupy significant memory space. SAX events on the other hand can be queried as parsing progresses (i.e. no need to wait for an entire DOM tree to be constructed before queries can be first performed) and are also light on memory (since no large DOM tree needs to be stored). Not needing to wait for an entire web document to download is a major advantage since this would otherwise be a major bottleneck. SAX events are method calls—e.g. Java software that calls code to perform an instruction.

Querying the SAX events can then be done using an event stream based engine of an object oriented XML query language. The engine can operate on a stream of events and does not keep the data in memory. The XML input which the query engine operates on is derived from the source web site which is being browsed/interrogated (e.g. for information relevant to finding the best odds/placing a bet etc). That web site typically provides HTML format data, which is translated into valid XML using a translation engine.

The translation engine can also fully define the nesting semantics (i.e. a parameterised list of rules to handle bad nesting, which is very commonplace on web sites) needed for efficient and valid XML: nesting is sometimes not done in HTML code, but is done in XML, so conventional HTML to XML translators address this problem by multiple closure/re-opening steps, but this leads to very large XML nested structures. Defining the nesting semantics allows for much more compact XML to be generated. The nesting semantics typically cover what tags will open/close a nested structure, what hierarchies of nesting are affected by what tags etc.

In one implementation, a mobile telephone user sends a request for a betting odds on a sporting event using a protocol which is device and bearer agnostic (i.e. is not specific to any one kind of device or bearer) over the wireless network (e.g. GSM, GPRS or 3G) operated by a mobile telephone operator (e.g. Vodafone). The request is directed to the operator, who then routes it through to a server (typically operated by an independent company specializing in designing the software running on such servers, such as Cellectivity Limited), which initiates a search through appropriate bookmakers web sites (or other resources) by using the above described web interaction system to locate the best available odds.

The web interaction system automates the entire web browsing process which a user would normally have to undertake manually. The user in effect delegates tasks to the web interaction system, eliminating the need for continued real time connection to the Internet The search may also depend on business logic set by the operator—e.g. it may be limited to bookmakers who have entered into commercial arrangements with the mobile telephone operator controlling the web interaction system.

The web interaction system interacts with web resources (not simply WAP, iMode or other wireless protocol specific sites), querying them, submitting forms to them (e.g. password entry forms) and returning HTML results to the translation engine. The translation engine converts the HTML into properly nested XML by generating SAX events; the query engine then applies appropriate queries to the SAX events in order to extract the required information and generally interact with the web site in a way that simulates how a user would manually browse through and interrogate the site in order to assess whether it offers bets of interest, to compare those best against other bets to determine the best odds and to actually place a bet.

Web Agents technology is a framework that allows easy, rapid and robust implementation of extremely lightweight software components that automate browsing on the world-wide web. The main idea behind the framework is to look at the web as a huge cluster of databases. It uses a transfer protocol support to link itself to and perform actions on such a “database”. It also queries the “database” using a query language, in order to extract information from it. The only thing the agent programmer needs to code is the specific way to link to this “database” and the specific structure for the data inside it.

The fundamental building blocks in the framework are
1. Transfer protocol handling support.
2. Parsing of content language support.
3. Querying content support.

By providing these three building blocks and linking them to one framework unit, Web Agents enables the ability to fully interact with any website, link to it, parse its content and query its content. The framework is written in Java and is built on top of the Java API for XML Processing (JAXP) and in particular the Simple API for XML (SAX). The use of the SAX standard enables better integration of the framework into other products and a very simple integration of any SAX functionality into the framework.

By using the Web Agents framework, the programmer has the complete solution to any activity she wishes to automate on the web. The generated agents are not limited to information extraction or web crawling, for example. There is no limit to any specific activity, specific transfer protocols or specific set of content languages.

User Interaction for a WAP Implementation

In the current implementation of Bet Cellect, bets can be made on golf tournaments and soccer. The Web Agents can search the following web sites
Paddy power—www.paddypower.com (Irish Site)
Luvbet—www.luvbet.com (Irish Site)
Hackett bet—www.hackettbet.com (Irish Site)
Ladbrokes—www.ladbrokes.com (UK Based)
William hill—www.williamhill.oc.uk (UK Based)

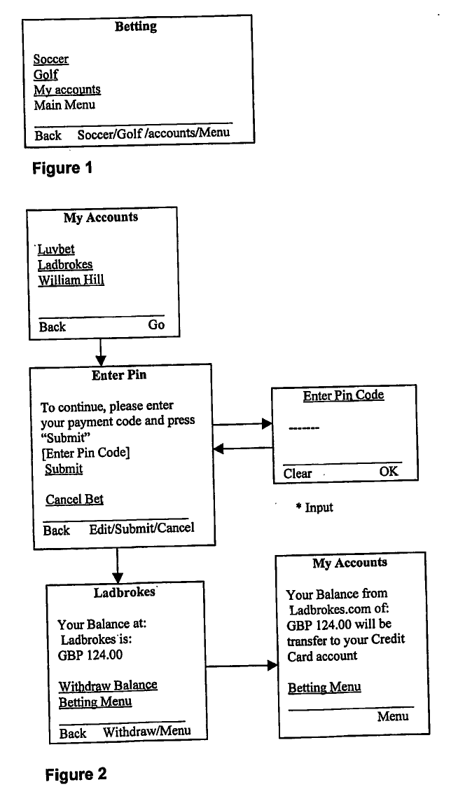

The betting application will search and present the best odd for the selected bet from the proposed betting sites. Once the user decides to place a bet, the application will create an account for him on the vendor site, will deposit the amount for the bet on his behalf and will place the bet. The application will also provide the user with his balance on the different vendor's sites and will allow the user to withdrew his balance. The main menu for a WAP implementation is shown in FIG. 1. It shows a menu list of four main selectable items (Soccer; Golf; My Accounts; Main Menu). If the user selects the ‘My accounts; option, then the screen shots shown in the FIG. 2 sequence are shown. These being with a listing of three different bookmakers the user has opened accounts with; if the user selects ‘Ladbrokes’ (the name of a bookmaker), then he is required to enter his PIN, after which his balance is shown. The balance can be credited to a pre-assigned credit card.

Soccer—Search Criteria

If the user selects the ‘Soccer’ option in the main menu (FIG. 1), then the soccer application is initiated. The soccer application involves the web agents technology interrogating soccer based web sites etc. and intelligently presenting the end-user device with screens (e.g. WAP cards) that give the user the most succinct information needed to enable the end-user to find what he wants to bet on, obtain the best odds and then place a bet, all with the minimum of data input on the device and the minimum of data traffic and the minimum of separate messages to and from the device.

The soccer application can return a result for two types of bets.
1. Bets on the winner of a league, championship or cup where the bets are on the winner of the tournament and not on a specific match.
2. Bets on the winner of a match (who will win the mach) Home, Draw or Away.

Bets on league's winner: user interaction steps are:
Select the preferred league
Receive best odds for each team to win the league

Bets on match's winner: user interaction steps are:
Search for the preferred league
Select the match for a bet
Receive best odds for Home, Draw and Away
Define user preferences:

The user is also able to define a list of his favorite teams and store it. When searching for a bet he will be able to search straight for a bet on his favorite teams without the need to insert any additional information. The results of the search will be presented as follow:

Bets on league's winner:
Title: The selected league:
A list of all the teams with the odds for each team

Bets on match's winner
Title: The selected match
Home—Best odd
Draw—Best odd
Away—Best odd

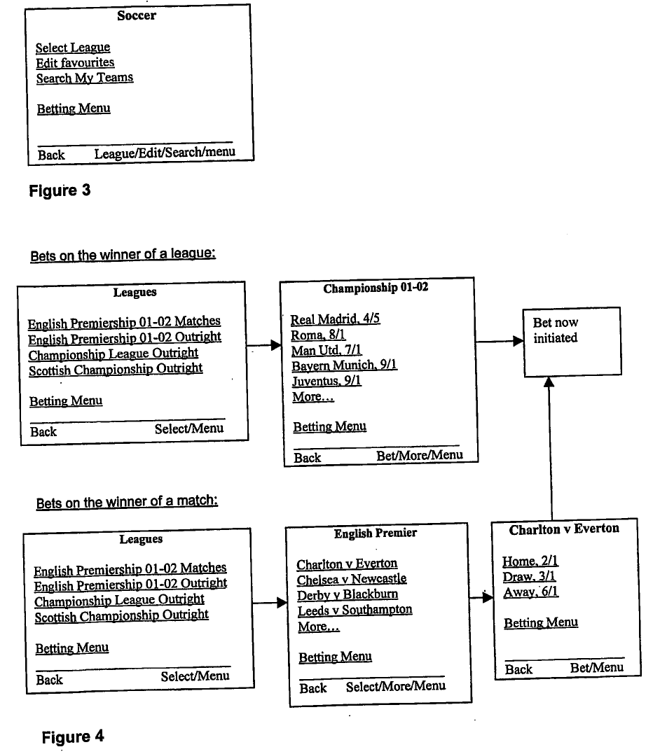

The above principles are applied as follows: The main soccer menu is shown in FIG. 3, which shown three main selectable items: Select League; Edit favourites and Search my teams.

If the ‘Select league’ option is chosen, then the user interaction flow is as shown in FIG. 4. As noted above, there are two main variants—betting on the winner of a league and betting on the winner of a match. In each case, the remote web agents system automatically obtains the best available odds and presents to the end-user device a highly simplified, minimal user interaction dialogue that allows the user to reach a screen showing view the best available odds with the minimum of key clicks.

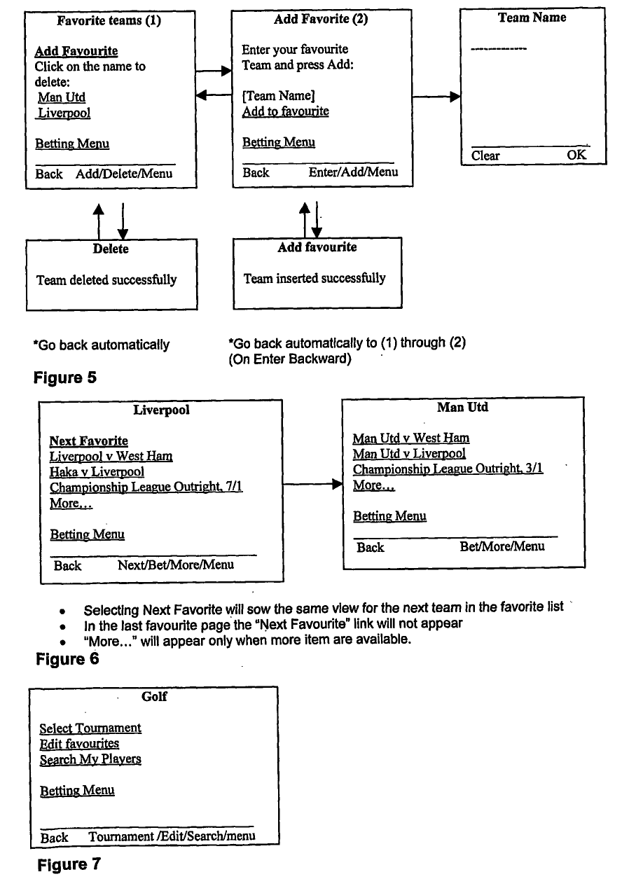

If the user selects the ‘Edit favourites’ option form the main soccer menu (FIG. 3), then the FIG. 5 user interaction flow is available. Again, these screen shots show how the user can rapidly and simply enter a favourite soccer team.

If the user selects the ‘Search my teams’ option, then the FIG. 6 user interaction flow occurs.

Golf—Search Criteria

The main search criteria for golf betting are:

Bets on a tournament's winner
Search for the preferred tournament
Receive best odds for each player to win the tournament
Define user preferences:

The user is able to define a list of his favorite players and store it. When searching for a bet he will be able to search straight for a bet on his favourite players without the need to insert any additional information. The results of the search will be presented as follow:

Bets on league winner:
Title: The selected tournament name
List of players and the best odd for each player to win the tournament

Bets on favorite players:
Title: The selected player
List of tournaments that the player is playing at and the best odd for him to win each tournament

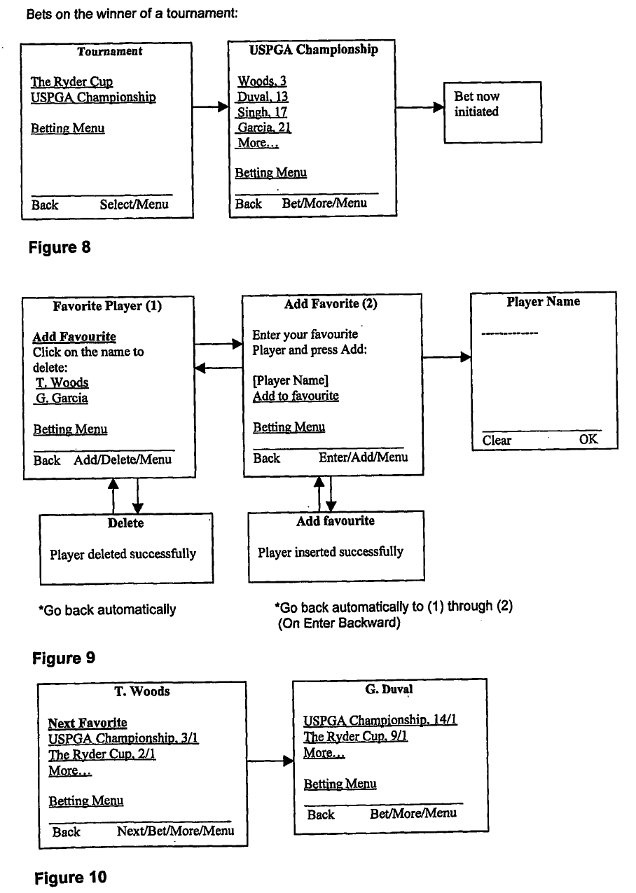

The main golf menu is shown in FIG. 7. This lists three main options: select Tournament, Edit favourites and Search My Players. If ‘Select Tournament’ is chosen, then the device screen user interaction is shown in FIG. 8. Various tournaments are listed in the first screen; for each selected tournament, e.g. USPGA, the best odds for each payer are obtained by the web agents technology, sent to the device and then displayed.

If ‘Edit favourites’ is selected, then the FIG. 9 user interaction takes place. If ‘Search My Players’ is selected, then the FIG. 10 user interaction occurs.

Betting Payment Functionality

This covers the following.

Check if the user has an account on the vendor site.

If the user doesn't have an account:
Create an account for the user and save his user name and password.
Deposit the amount for the bet in the account.
Place the selected bet.
Send a confirmation to the user with the transaction and the bet details.

If the user has an account:
User can use an account that he created previously on the web (he will have to enter his user name and password on the preferences site), or an account that was created previously by the application.
The application will show the user balance in the account and will ask for the amount of the bet.
   The balance on the account is higher the required bet
   The application will place the bet without additional deposit.
   The balance on the account is lower the required bet
   The application will notify the user that he required additional deposit and will place the bet according to his response.

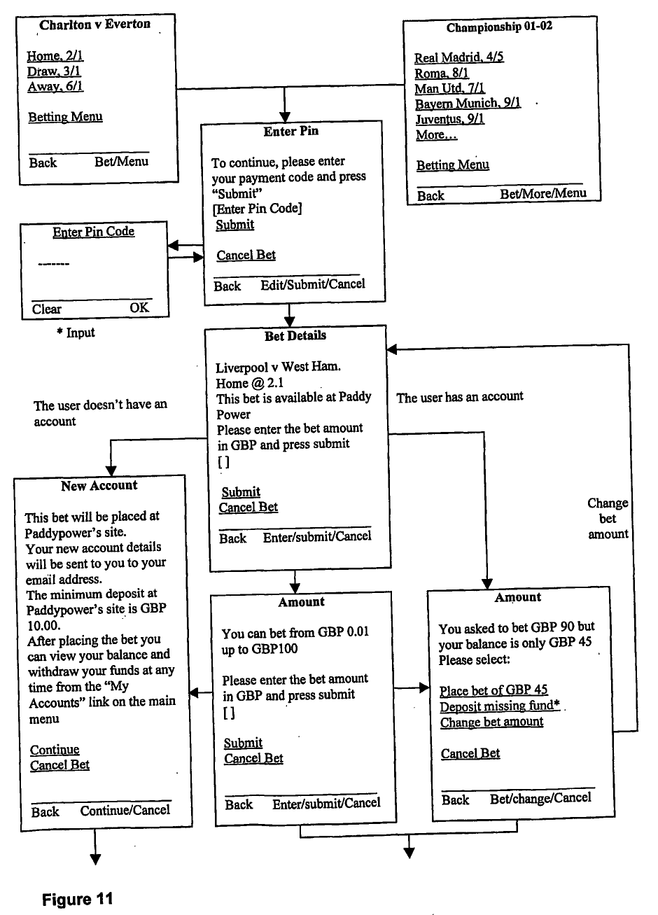

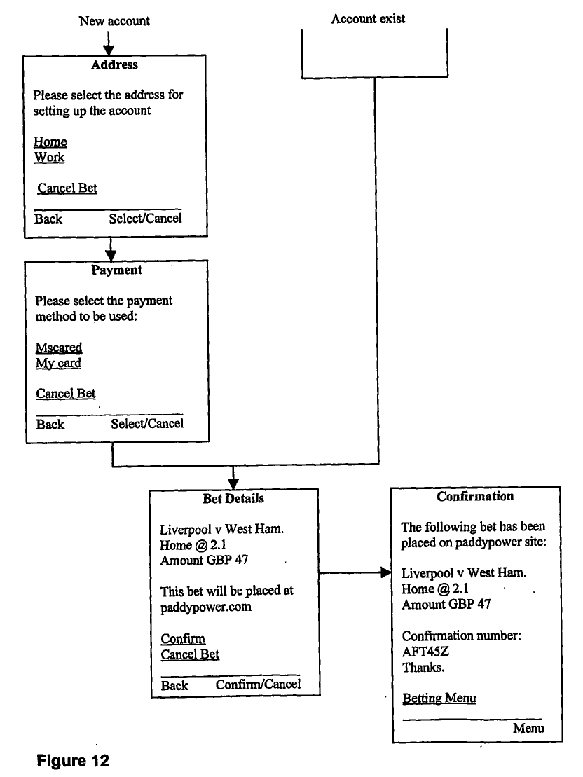

The overall user interaction sequence for placing a bet is shown in FIG. 11. Here, the user has found the best odds on various soccer matches. Assume he selects a match; he then enters his PIN to initiate the placing of the bet; once the PIN is verified, he is then shown a ‘Bet Details’ screen, asking him to enter the amount in GBP he wishes to bet. If the user does not have an account, then he is taken through the options needed to open an account, as shown in the continuation of FIG. 11, FIG. 12. If he does have an account, but with insufficient funds, he can change the bet amount. Finally, he will reach a Bet Details screen, shown in FIG. 12, summarising the bet and giving him the option of confirming (or cancelling) the bet. If confirmed, a bet confirmation is sent and displayed.

SMS Betting

The present invention can also be implemented using SMS. The SMS interface for betting is similar to using the Search My Teams function with WAP. The user is able to send name of a team/player or the words BET, BETTING, SOCCER, or GOLF and will get a reply accordingly.

Establish the Communication

The required data to initiate a search contains the following:
“Betting”
“Soccer” or “golf”
Team/player [Name]
League [#]

The system should search for this information in the received SMS.

### EXAMPLE 1

Received: betting

Reply: Hello, to bet on golf player reply “Player ______”, to bet on a soccer team reply “Team ______”, to receive list of bets Reply “Soccer” or “Golf”

### EXAMPLE 2

Received: SOCCER

Reply: Hello, please reply “team [Name]” or: “League#______”

1 Eng Prem Matches

2 Eng Prem Outright

3 Cham's Outright

4 Scot's Prem Outright

### EXAMPLE 3

Received: GOLF

Reply: Hello, please reply: “Player [Name]” or: “League#______”

5 Us Masters

6 Euro order of merit

Results for Teams

Received: Team Liverpool

Reply:

Liverpool

Reply: “Bet______GBP on #______”:

1 Lose V Leeds, 13/10

2 Champions League Outright, 16/1

3 Win V Leeds, 13/8

Reply: “More” for more results.

Received: More

Reply:

Liverpool

Reply: “Bet______GBP on #______”;

4 English Premiership 2001-2002 Outright, 15/2

5 Draw V Leeds, 11/5

Results for League (Matches)

Received: LEAGUE 1

Reply:

English Premiership 2001-2002 Matches

Reply: “Match #______”

1 Leicester V Chelsea

2 Everton V Ipswich

3 Leeds V Liverpool

Reply: “More” for more results.

Received: More

Reply:

English Premiership 2001-2002 Matches

Reply: “Match #______”

4 Man Utd V Sunderland

5 Arsenal V Southampton

6 Newcastle V Bolton

Reply: “More” for more results.

Results for League (Outright)

Received: LEAGUE 2

Reply:

English Premiership 2001-2002 Outright

Reply: “Bet______GBP on #______”

1 Chelsea, 22/1

2 Leeds, 14/1

3 Man Utd, 8/11

4 Arsenal, 9/4

Reply. “More” for more results.

Received: More

Reply:

English Premiership 2001-2002 Outright

Reply: “Bet______GBP on #______”

5 Newcastle, 16/1

6 Liverpool, 15/2

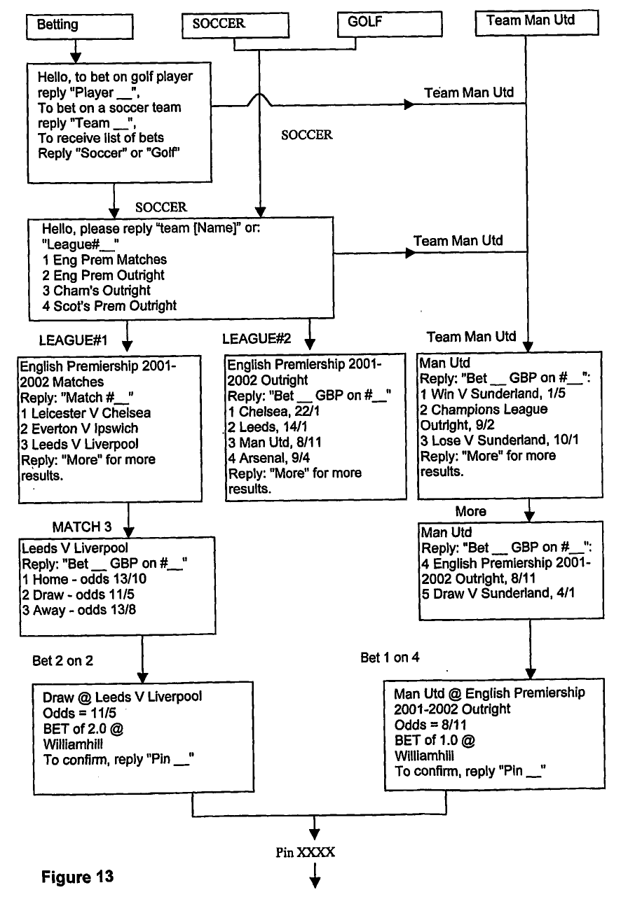

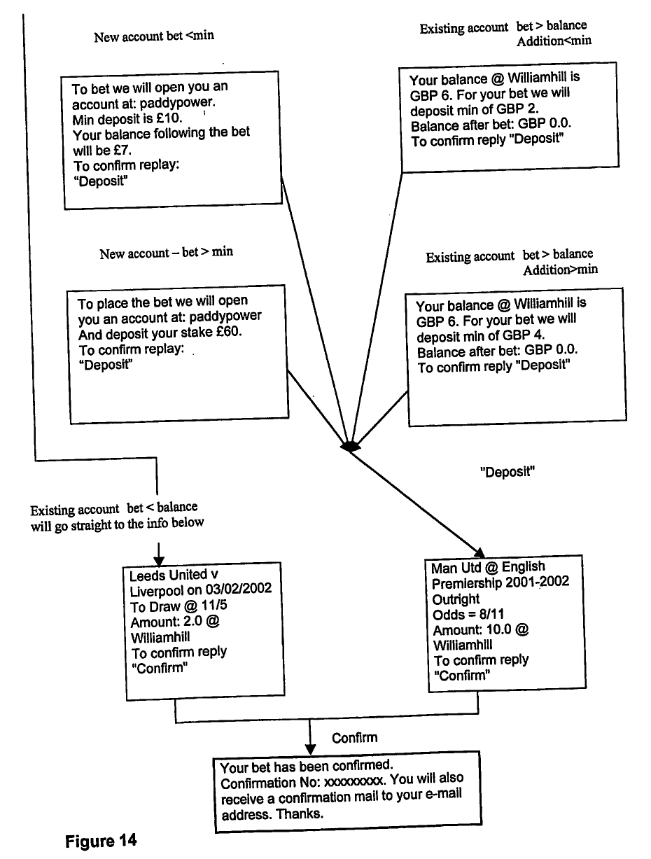

FIG. 13 and its continuation FIG. 14 shows the process flow for SMS based betting on soccer. The process begins with a user receiving a SMS text message giving the main betting options, including the option To bet on a soccer team reply “Team______”. If the user replies “Team Man Utd” then the user receives a SMS text message “Man Utd Reply; Bet______GBP on #_”, followed by a numbered list of games/leagues. The user can ask for more information (i.e. on other games) or actually place a bet by sending a reply SMS in the stipulated format—e.g. “bet 1 on 4” to place a £1 bet on listed bettable event 4—to win the English Premiership outright, at 8/11 odds. To confirm the bet, the user simply has to input his PIN, which (assuming an account is open and has sufficient funds), will result in the bet confirmation shown in FIG. 14. If a new account has to be opened or there are inadequate funds in an existing account, then the user interaction process is also shown in FIG. 14.

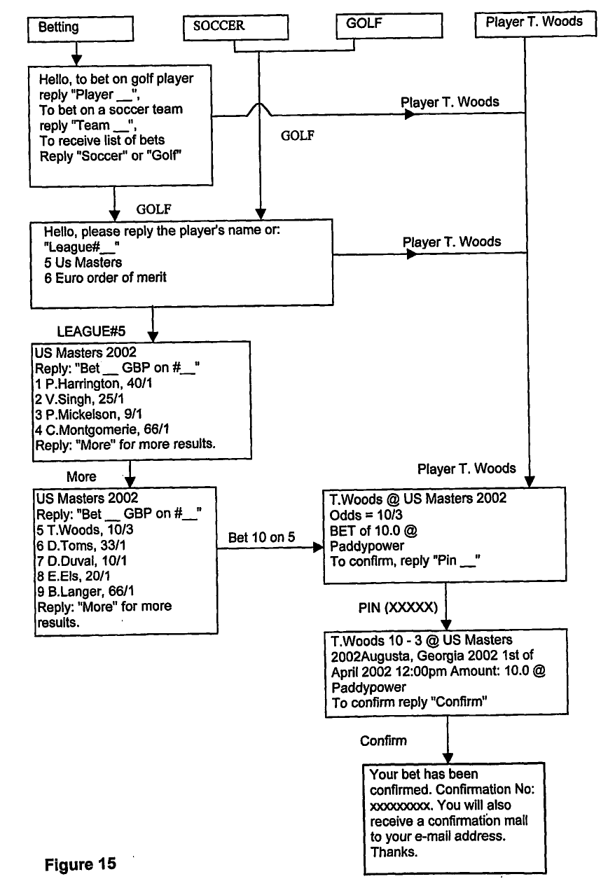

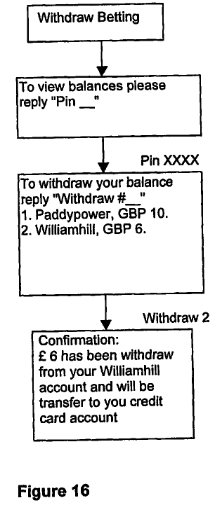

FIG. 15 shows the process flow for SMS based betting on golf. FIG. 16 shows the SMS based process flow for withdrawing money.

In addition, the Bet Cellect system provides full reporting statistics over the Web (both for the individual bettor and in aggregated format to the operator)

a. User's reports:
i. User's transactions report including all the transaction that he did via the Bet Cellect service
ii. A detailed transaction information record

b. Operator's reports:
i. Complete users transaction for selected operator
ii. Monthly and weekly reports:
   1. Transaction breakdown by vendors
   2. Transaction breakdown by service

c. Vendor's reports:
i. Complete users transaction cross operators
ii. Monthly and weekly reports:
   1. Transaction breakdown by operator
   2. Transaction breakdown by service

All the transactions are logged: bets, deposits, withdrawals, open accounts, and purchases. The access to user's data is limited since the operator can see only their own users and vendors can see only transactions on their site

1. A method of enabling a wireless information device to access betting related services, comprising the steps of:
(a) receiving and displaying on the device the best odds on an event as automatically selected from odds offered by two or more bookmakers;
(b) displaying on the device an option to initiate placing a bet at the best odds; and
(c) sending from the device instructions to place the bet.

2. The method of claim 1 in which the best odds and the option to initiate placing a bet at the best odds are displayed together on the same screen so that the user does not have to navigate to a different screen in order to initiate placing the bet.

3. The method of claim 1 in which the best odds on an event and the option to initiate placing a bet at the best odds are displayed on hyper-linked screens so that the end-user does not have to manually navigate to and open a different remote site to move from one to the other.

4. The method of claim 1 in which the option to initiate placing a bet is one or more of:
(a) highlighting or underlining the name of the event, team or player for which the best odds have been located.
(b) a dedicated button or icon;
(c) a statement defining the format of a message reply that would need to be sent from the device in order for a bet to be placed.

5. The method of claim 1 comprising the step, to precede step (a), of: sending from the device a single instruction to find the best odds on an event.

6. The method of claim 1 comprising the step, to precede step (a), of: receiving and displaying a tip relating to an event, the tip giving the name of the event and the applicable odds, which are the best available odds offered by two or more bookmakers.

7. The method of claim 6 in which the option to initiate placing a bet is a statement defining the format of a message reply that would need to be sent from the device in order for a bet to be placed and the instructions to place a bet is a reply in the required format.

8. The method of claim 1 in which finding the best odds from two or more bookmakers is achieved using a web agent that automatically searches one or more of the following defining available odds:
(a) web or WAP sites from two or more bookmakers;
(b) databases controlled by two or more bookmakers;
(c) back-end processing systems of two or more bookmakers;
(d) a data stream received from any of the above.

9. The method of claim 1 in which the best odds are received as a SMS message.

10. The method of claim 1 in which the instructions to place the best are sent as a SMS message.

11. The method of claim 1 comprising the steps of:
(a) displaying on the device an option to select a favourite team or sportsperson; and
(b) sending from the device instructions to select a specific favourite team or sportsperson.

12. The method of claim 11 comprising the step of
(a) receiving and displaying on the device the best odds on a sporting event relating to the selected team or sportsperson;
(b) displaying on the device an option to initiate placing a bet at the best odds; and
(c) sending from the device instructions to place the bet.

13. The method of claim 1 comprising the steps of displaying a series of menu options which when selected enable an end-user to open an account with a bookmaker and credit that account with money.

14. The method of claim 13 in which the step of sending from the device instructions to place the bet causes the account to be debited.

15. The method of claim 13 in which winning a bet causes the account to be credited.

16. A wireless information device programmed to access betting related services, in which the device is operable to:
(a) receive and display the best odds on an event, as automatically selected from odds offered by two or more bookmakers;
(b) display an option to initiate placing a bet at the best odds;
(c) send instructions to place the bet.

17. (canceled)

18. A wireless network operator that controls a wireless network, in which the network carries data traffic to a wireless information device to enable the device to receive and display the best odds on an event as automatically selected from odds offered by two or more bookmakers; and carries data traffic from the device to enable the device to place a bet in response to an end-user selecting an option displayed on the device to initiate placing a bet at the best odds.
